(19) United States
(12) Patent Application Publication
(10) Pub. No.: US 2021/0357190 A1
(43) Pub. Date: Nov. 18, 2021

(54) AESTHETIC VISUALIZATIONS BY AUTO-OPTIMIZING CONNECTORS IN WORKFLOWS

(71) Applicant: SAP SE, Walldorf (DE)

(72) Inventors: Prabal Mahanta, Bangalore (IN); Abdul-Gafoor Mohamed, Bangalore (IN)

(21) Appl. No.: 16/910,558

(22) Filed: Jun. 24, 2020

(30) Foreign Application Priority Data
May 12, 2020 (IN) 202011020007

(51) Int. Cl. G06F 8/38; G06F 8/34; G06F 8/33; G06F 8/35; G06F 16/25

(52) U.S. Cl. CPC G06F 8/38; G06F 8/34; G06F 16/254; G06F 8/35; G06F 16/252; G06F 8/33

(57) ABSTRACT

According to some embodiments, systems and methods are provided, comprising: receiving, at a user interface, a plurality of operator blocks and at least one connector for connecting the operator blocks to generate a dataflow model, wherein each connector includes a first endpoint and a second endpoint; receiving an annotation file for each operator, wherein the annotation file is received when the operator is received at the user interface; receiving at the user interface a positioning of each connector to connect two operator blocks; and generating a layout of the dataflow model on the user interface based on one or more semantic rules and one or more geometric rules. Numerous other aspects are provided.

### CROSS-REFERENCE TO RELATED APPLICATIONS

This application claims priority to Indian Provisional Application No. 202011020007, filed May 12, 2020, the contents of which are incorporated by reference herein for all purposes.

### BACKGROUND

“Big data” commonly refers to data that contains greater variety arriving in increasing volumes and with ever-higher velocity than heretofore conventional data. “Big data”, or any other data sets that are too large or complex to analyze or extract information from using traditional data-processing application software, may be useful to address questions and problems that would not have been addressable prior to the availability of big data. Currently, analyzing big data without Extract Transform Load (ETL) processes is not possible without investing in User Interface driven approaches (e.g., Product may use OpenUI5 framework which is a JavaScript application framework designed to build cross-platform, responsive enterprise-ready applications) and Interface embedded functionalities. This process of creating user interfaces with features adding to the process of analytics is driven primarily using workflows which a user configures using the User Interface.

The workflows provide a visualization of the flow of data in response to data analysis-driven queries. However, a given workflow may be complex and include multiple operators, and might not include any annotations to assist the understanding thereof. Currently, understanding the flow of data within a workflow is a Non-deterministic Polynomial-time (NP) hard problem. Such complex scenarios may be difficult to debug, and without executing the workflow, it may be very difficult to understand the trace of data flow. This is often due to the nature of the enterprise application. As a non-exhaustive example, in a case of a real time processing and workflow step not having the desired configuration to handle certain specific scenarios, it would be undesirable to debug because the new data can only be retrieved at runtime.

Systems and methods are desired which support the efficient annotation and presentation of visualized workflows.

### BRIEF DESCRIPTION OF THE DRAWINGS

FIG. 1 is an outward view of two workflows in a user interface according to the prior art.

FIG. 2 is a flow diagram of a process according to some embodiments.

FIG. 3 is a flow diagram of a process according to some embodiments.

FIG. 4 is an outward view of a graphical interface according to some embodiments.

FIG. 5 is an outward view of a graphical interface according to some embodiments.

FIG. 6 is an outward view of a graphical interface according to some embodiments.

FIG. 7 is an outward view of a graphical interface according to some embodiments.

FIG. 8 is an outward view of a graphical interface according to some embodiments.

FIG. 9 is a block diagram system architecture according to some embodiments.

FIG. 10 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) to implement the specific techniques set forth herein.

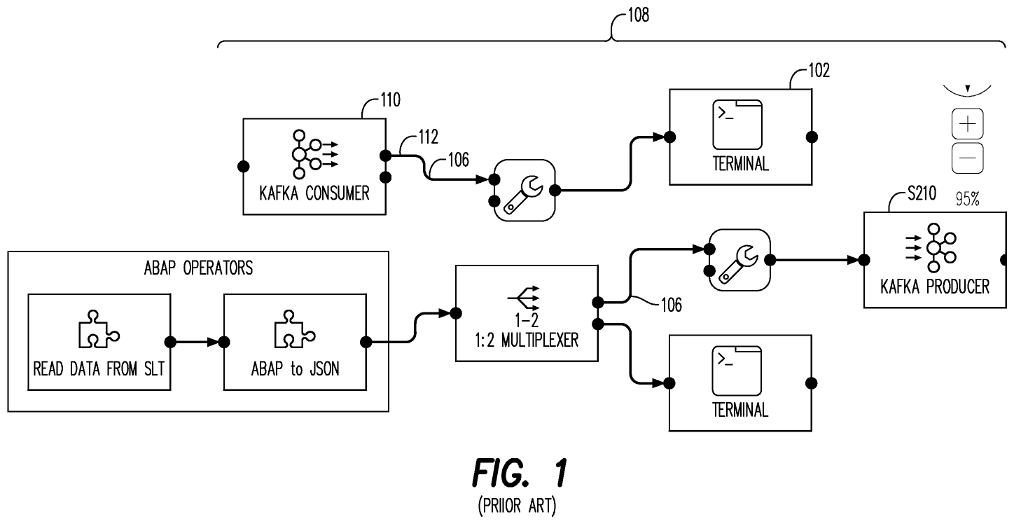

When performing analysis in a “Big Data” space, a user may generate one or more models in the form of data flows. In the “Big Data” space, these data flow models may be referred to as data pipelines. A data pipeline may refer to scenarios which require data movement and/or data transformation. Workflows may represent the complex scientific scenarios. The data flow model may define a flow between the elements such as “Aggregators”, “Joins”, etc. depicted via a User Interface. Workflow may also apply symbolically to the modeling process using operators representing dataflow or business scenario-based workflows. As shown in FIG. 1, two simplified versions of a data flow model are provided as a conventional visualization 100. The top non-exhaustive example represents a Big Data pipeline 102, while the bottom non-exhaustive example represents a HANA workflow 104 per SAP HANA® of SAP SE. The conventional visualization may be confusing and may not be aesthetically pleasing with a variety of non-linear (e.g., 106) arrows coming in and out of boxes. Adding to the confusion and lack of aesthetics may be elements (e.g., block operators and otherwise, and connectors) with different sizes with respect to the canvas (i.e., the container or space in which the UI elements are laid out and rendered), the distance between operators, the distance between the operator inputs/output, the canvas size, and the number of operators. The variable nature of the output may make it a challenge to arrange the output connectors in a clear manner. The more complex the scenario, the messier/more confusing or muddled the visualization may be. When a developer creates the visualization, they know how the data is supposed to flow in the dataflow, so the conventional arrangement of the User Interface (UI) elements 108 (e.g., blocks 110 and connectors 112) in the visualization may not be problematic for them at that instant. However, when another user needs to review the visualization 100 to debug an issue with the dataflow model and determine which operator is involved in the issue, or when the developer reviews the visualization at a later time, they may have trouble tracing the flow of data in the data flow. It may be particularly troublesome without executing the data flow, and as described above, it may be undesirable to execute the data flow.

Additionally, this conventional visualization may not account for the logical aspect of the data in that each block may represent an operator, which may have cardinality of multiple outputs and at least one input in many cases. The logic may not show itself in the typical visualization. Conventionally, these annotations are human driven, which may in some instances, lead to a lack of annotations or insufficient annotations. Annotations are specific fine-grained information for an operator element in the canvas or the user interface, which comprises a position, as well as operation information with an ability to transform the operator element into a business scenario. Further, the conventional visualization may include the same annotations for each operator, with no clear information based on a hierarchy level of the User Interface element. Typically, the information of any operator starts with basic name and usage. Alternatively, in some embodiments, the annotations may include an information management aspect whereby information is collated when several operators contribute to the dataflow model representing a business scenario where information about the transposed data is also maintained. Some embodiments may also include the data with JSON representation with the annotations. Further, a user may expand an operator in an attempt to debug the data flow, for example. However, conventional operators may not include annotations and so the expanded operation may be blank. When developers are asked to debug the dataflow model and there are no annotations, there may not be guidance support from the UI level for how to debug the dataflow. This lack of guidance is especially challenging in the debugging of aggregation scenarios. As a non-exhaustive example, in a scenario where multiple segregations or analytical transformations are involved, it is not possible to debug without having to go through hierarchy (layer of elements) of elements. It is noted that conventional dataflow modeling may include an auto-arrange feature whereby the elements are positioned in the canvas based on predefined arrangement or wrapping, which may lead to a poor user experience. Traditionally the placement is based on linear arrangement of operators with connections being flexible and placed in a manner to align with the element's ports. The problem with the conventional auto-arrange is that it obviates any of the organization the developer may have included in the dataflow model.

One or more embodiments provide a process to build aesthetic visualizations of a dataflow by auto-optimizing connectors in the dataflow using a module that addresses the semantic arrangement, labeling and alignment of the operators in the data flow. One or more embodiments provide for rending an active state that includes the set of viewpoints of operators for optimizing efficiency, finding discriminative candidate elements in all layout views; creating annotations by learning the element behavior in terms of layout and purpose; and creating a semantic layout for element layout and change detection alignment procedure.

One or more embodiments provide for the inclusion of annotations and comments, via a visualization module, for each element (i.e., operator/block/connector) in the data flow model. Also, one or more embodiments provide for the alignment of the elements, via the visualization module, in a way that makes it visually apparent which tables were aggregated and placed together. One or more embodiments also include a time for data processing and a state of processing, via the visualization module, to allow a user to debug an appropriate element in an efficient manner. By including the alignment, annotations, comments and timing/processing, one or more embodiments may optimize the dataflow model, thereby allowing users to more easily debug and understand the dataflow model without having to execute the dataflow model.

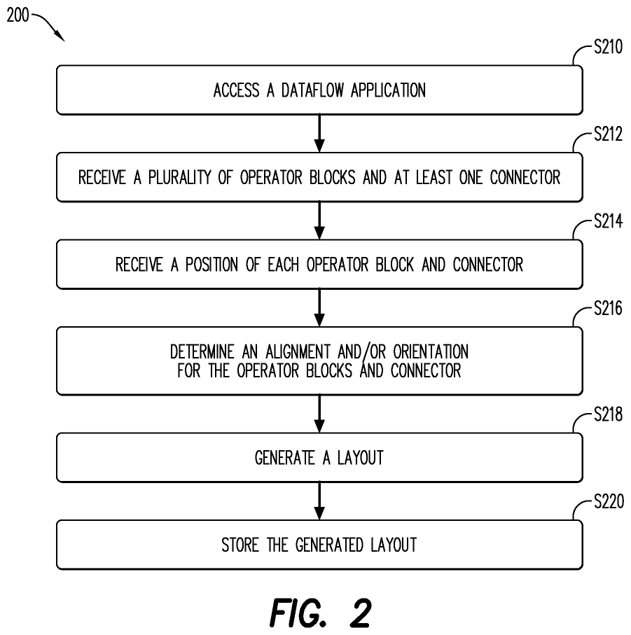

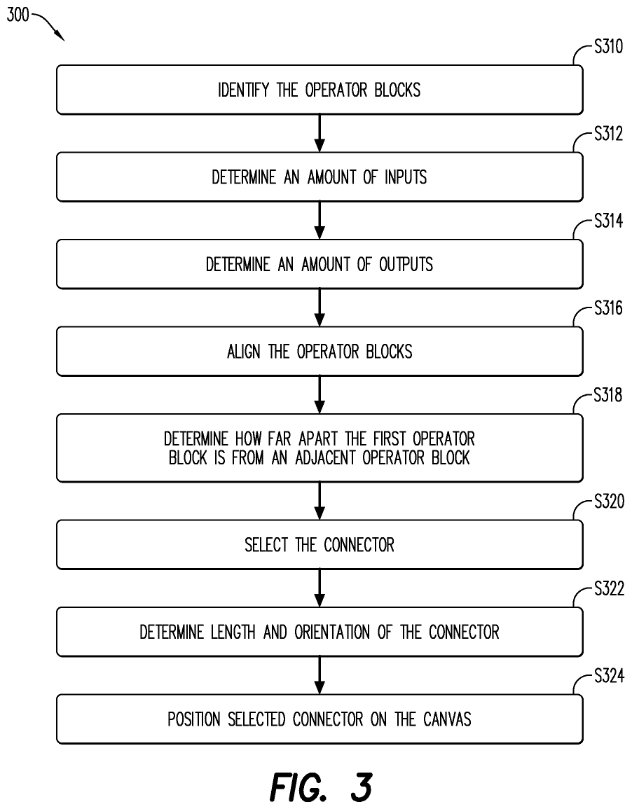

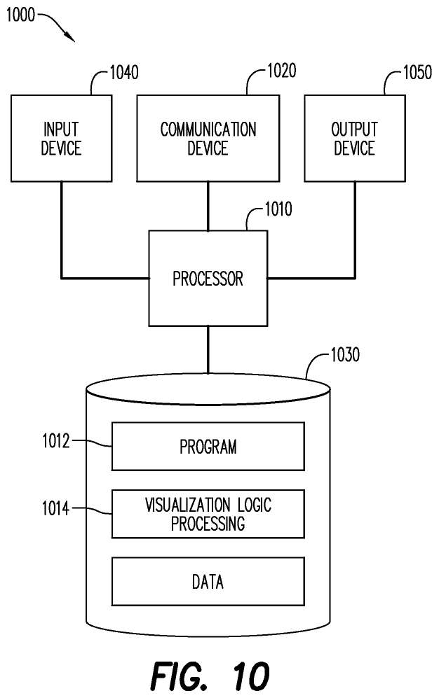

FIGS. 2-8 include a flow diagram of a process 200/300 (FIGS. 2 and 3) described with respect to an outward view of user interfaces according to some embodiments. Process 200/300 may be executed by application server 940 according to some embodiments. In one or more embodiments, the application server 940 may be conditioned to perform the process 200/300, such that a processor 1010 (FIG. 10) of the server 940 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

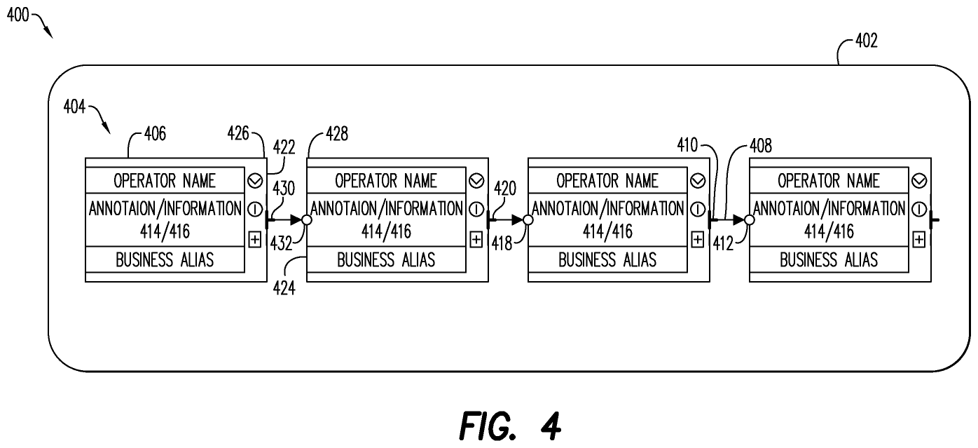

User interface 400/600/700/800 may be presented on any type of display apparatus (e.g., desktop monitor, smartphone display, tablet display) provided by any type of device (e.g., desktop system, smartphone, tablet computer). One or more embodiments may include a UI renderer (not shown) which is executed to provide user interfaces 400/600/700/800 and may comprise a Web Browser, a standalone application, or any other application. Embodiments are not limited to user interface 400/600/700/800 of FIGS. 4, 6, 7 and 8.

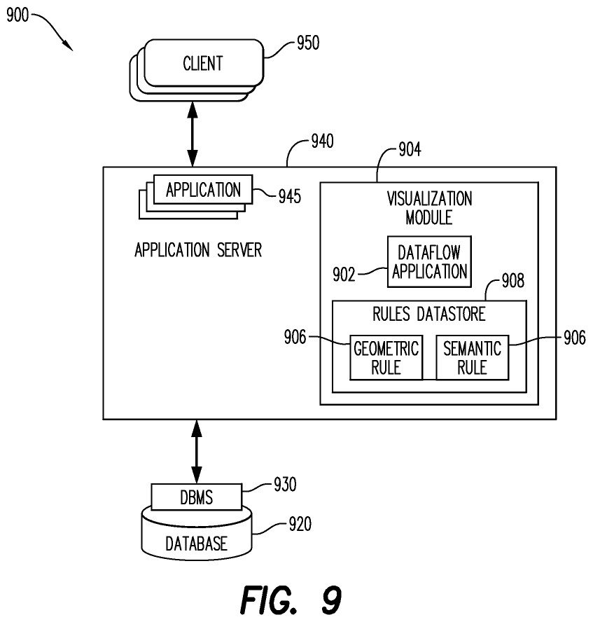

FIG. 2 describes a process 200 for building a dataflow, according to one or more embodiments. Initially, at S210, a user (now shown) may log into a system and access a dataflow application 902 (FIG. 9) to generate a dataflow model 404. The dataflow application 902 may provide a user interface 400 (FIG. 4), and in particular, a canvas 402 on which to create the dataflow model 404. It is noted that the user interface 400 may be specific for an individual user based on the log in information, or may be a general user interface (UI). Then at S212, a plurality of operator blocks 406 and at least one connector 408 is received on the canvas 402. Other elements besides operator blocks and connectors may be received in the canvas, including but not limited to a prepackaged data flow model which may be required in the current scenario where there may not exist an operator to signify the particular functionality. In one or more embodiments, the user may select the operator blocks 406 and at least one connector 408 from a list (not shown) of available operator blocks 406 and connectors 408, or may create an operator block and/or connector via tools provided by the dataflow application 902. In one or more embodiments, selection may be via check-box, highlighting, drag-and-drop, or any other suitable selection process. Execution of the selection may result in the operator blocks and the connector(s) being received on the canvas 402. Non-exhaustive examples of operator blocks include File readers, Database connection, Messaging Queues, etc. In one or more embodiments, the connector 408 may connect at least two operator blocks 406 or other elements to generate a dataflow model 404. The connector 408 may indicate the direction of data flow via arrows or any other suitable indicator. Each connector 408 includes a first endpoint 410 and a second endpoint 412.

In one or more embodiments, when the operator block 406 is received on the canvas 402, one or more annotations 414 and other information 416 associated with that operator block 406 are automatically imported with the operator block from a data store 920. As used herein, the annotations 414 may include the name and purpose, while other information 416 may include usage and parameters related to configurations. The operator blocks, as well as the layouts, and decision scenarios described herein are built on top of a database 920. When the operator blocks are placed in the dataflow model, the existing annotation information (e.g., the database source of the operator) for that block is imported with the operator block. In one or more embodiments, a trained dataset is stored in a visualization module 904 that defines which annotations are linked to which operator blocks. In one or more embodiments, the dataset to define the annotations was created by learning the element/operator block behavior in terms of layout and purpose of the operator block and/or dataflow model. As a non-exhaustive example, for a chatbot data creation, users may take up various approaches to define the best fit for data and taxonomy to enable better feedbacks. By linking the operator block to annotations 414 prior to execution of the process 200, this avoids accumulating too much data on top of the operator block in the visualization (e.g., display) on the canvas 402, which may clutter the visualization, and also ensures that appropriate annotations 414 are included for the operator block, instead of relying on a user to include the appropriate information with each dataflow build.

Next, in S214, a positioning of each operator block 406 and connector 408 is received on the canvas 402 to connect two operator blocks 406. In one or more embodiments, this is the initial placement of the operator blocks/connectors on the canvas by the user.

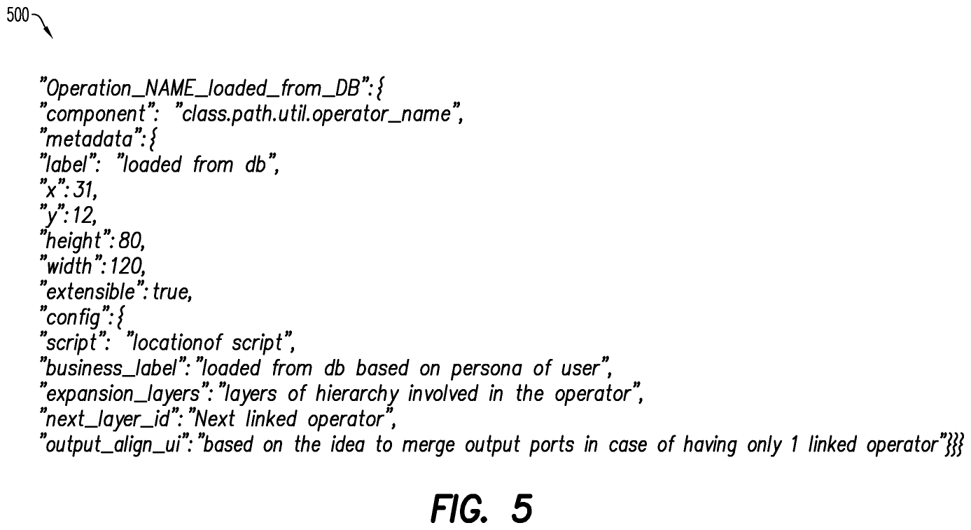

Then, the visualization module 904, may determine an alignment and/or orientation of the two operator blocks 406 and connector 408 based on one or more rules 906 (semantic rules and geometric rules) in S216, with the alignment process further described below with respect to FIG. 3. The alignment may be horizontal (i.e., from left-to-right, right-to-left) or vertical (i.e., top-to-down and down-to-top), or any other suitable alignment. After determining the alignment and/or orientation of the two operator blocks 406 and the connector 408, the visualization module 904 generates a layout of the dataflow model 404 on the canvas 402 in S218. In addition to the alignment process described further below, one or more embodiments may use mixture modules within a layout-based paradigm with the use of Principal Component Analysis (PCA) or Fisher Discriminant Analysis (FDA) (also known as Linear Discriminant Analysis (LDA), along with learning the context of the operator blocks/connectors in the model from the various annotation sets and any scenario-based trainings to further assist in the alignment and layout process. The generated layout/visualization of the dataflow model 404 may be stored in a data store 920 in S220. The generated layout of the dataflow model 404 may be stored as a JSON 500 (FIG. 5) or any other suitable format. It is noted that JSON may be the easiest way to manipulate the information, and may be very efficient from a storage point of view. The generation of the JSON file of the generated layout may be referred to as a “rendering of the active state” of the dataflow model 404. In one or more embodiments, the JSON file 500 may be further segmented into phases with particular parameters. Determining the underlying JSON code segment for each block effectively segments the dataflow model 404. As used herein, “phases” may be the scenario stage where initial operations start with transformation and data migration. The visualization module 904 may then analyze each phase with respect to how the data is flowing and may provide a recommendation to the user for a more optimal dataflow model 404, with respect to designing the operators in terms of determining ports and annotations. In one or more embodiments, the visualization module 904 may analyze all of the dataflow model layouts stored in the datastore 920 to find discriminative candidate elements to optimize the efficiency of the dataflow model. For example, the recommendation may be to parallelize some dataflows in the dataflow model 404, restructure the dataflow model 404, to remove some aspect of the dataflow model which may not be required or may be redundant, or to extend the dataflow model. As a non-exhaustive example, a dataflow model may already exist, and a developer wants to expand that scenario. In the existing dataflow model, the operators, inputs/outputs, and other parameters are already defined, so the visualization module 904 may indicate how the data is currently flowing per the dataflow model, and may recommend the next optimal operator to extend the dataflow. In one or more embodiments, the recommendation may be output from a machine learning model at the visualization module or any other suitable data source.

It is noted that in one or more embodiments, the visualization module 904 may automatically incrementally align the operator blocks and connectors (and other elements) as the developer connects them in the canvas 402. In some embodiments, the visualization module 904 may automatically align the operator blocks and connectors after a predetermined number of elements are added to the canvas, or at some other suitable time. In some embodiments the user may select the execution of the visualization module 904 to align the elements on the canvas via any suitable selector (e.g., button, tab, etc.). It is further noted that while elements (e.g. operator blocks and connectors) on the left of an operator block 406 may be considered “input” and elements on the right of an operator block 406 may be considered “output,” this designation may be reversed, and other suitable designations may be used (e.g., a flow from top to down, or down to up).

Turning to the alignment process 300 in FIG. 3, in one or more embodiments, initially at S310, the visualization module 904 may identify the operator blocks 406 on the canvas 402. In one or more embodiments, the identification may be based on a JSON file corresponding to that operator block 402 and the parameters for that operator block 406. The visualization module 904 may then determine an amount of inputs 418 for each operator block 406 in S312 and an amount of outputs 420 for each operator block 406 in S314. It is noted that the order of S312 and S314 may be reversed. In one or more embodiments, the number of inputs 418 and the number of outputs 420 for each operator block 406 may be selected by the user or may be linked to a given operator (e.g., A specific operator includes two inputs and one output). It is noted that the user may change the number of inputs/outputs for a given operator block 406. Determination of inputs 418 and outputs 420 may occur when the user selects the operator blocks or at some other time prior to alignment.

In one or more embodiments, the visualization module 904 may align the operator blocks 406 based on both geometric rules and semantic rules (“semantic alignment”). The order of consideration of the geometric and semantic rules may be any suitable order. Regarding the semantic rules 906, the visualization module 904 may strictly place operator blocks 406 to ensure that an operator block 406 with a mandatory requirement of an input 18, for example, may not be executed and/or stored by the visualization module 904 without a source of the input. This adherence to the semantic rules may be referred to as “pre-emption of data flow”. The visualization module 904 may analyze the JSON file 500 associated with operator blocks 406 to determine, for example, what data is being input to the operator block 406, the source of that data (e.g., the annotation data 414), and how that data is being manipulated, to adhere to the semantic rules 906. Semantic alignment with the JSON information may be based on the operator details and configurations which are maintained in the JSON. The operator placement in the canvas/user interface may also be determined based on in the JSON information. In one or more embodiments, the semantic rules 906 may be based on a trained dataset that was trained by a suitable machine learning process. In one or more embodiments, the visualization module 904 may also assign a time stamp to dataflow model and canvas metadata to manage change preservation to the data flow model 904. In one or more embodiments, the semantic rules 906 may also relate to the implementation of a pre-defined data flow via operators tagged with an operational objective defined using previous usage data, such that the order of the operators in the pre-defined data flow is correct. As will be discussed further below, with a pre-defined data flow, annotations 414 and input/output alignments are pre-fetched from the database 920, and may be tagged with the user need for those particular operator blocks. The information and arrangement of ports—input and output—is also enabled using the j son where there may be separate parameters to define this.

Additionally, the visualization module 904 may, in one or more embodiments, semantically align the operator blocks using geometric dispersion rules 906. As used herein, geometric dispersion rules may include rules for the arrangement of operators in case of multiple operators in the canvas based on business scenarios.

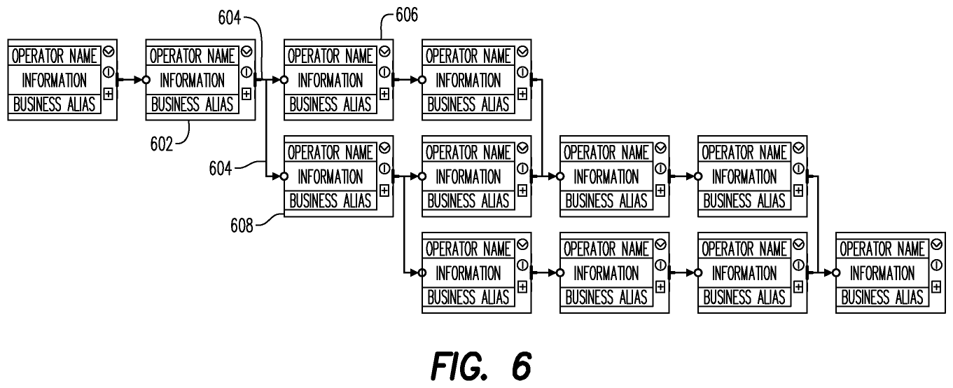

Then in S316, the visualization module 904 aligns the operator blocks 406. To align the first two operator blocks with each other, the visualization module 404 determines an edge 422 of a first operator block (“first operator block edge”) that faces, and is adjacent to, an edge 424 of a second operator block (“second operator block edge”). The visualization module 904 may make this determination based on pixel positions of the operator blocks 406. The pixel positions of the operator blocks 406 may also reveal the vertices of the first operator block edge 426 and the vertices of the second operator block edge 428. It is noted that pixel position helps in determination of arrangement of preceding and succeeding operators based on a given business scenario which is designed using the operators. After determining the first operator block edge 422 and the second operator block edge 424, and vertices for each of the first and second operator blocks 426, 428 the visualization module 404 may dynamically position the first and second operator blocks 406 on the canvas 402 such that a midpoint 430 on the first operator block edge 422 aligns with a midpoint 432 on the second operator block edge 424. As used herein, a midpoint of an edge is halfway between the vertices of that edge. It is noted that when there are more than two operator blocks being aligned, the visualization module 904 may first align the blocks vertically and second horizontally, or vice versa. As a non-exhaustive example, a first operator block may have three outputs, each of which is received as in input to a second operator block, a third operator block, and a fourth operator block. In this example, the visualization module 904 may vertically align second, third and fourth operator blocks per the midpoints of their adjacent edges, and then may align the first operator block with the middle one of the second, third and fourth operator blocks. As another non-exhaustive example shown in FIG. 6, when there is a first operator block 602 being aligned with an even number of operator blocks (e.g., a second operator block 604 and a third operator block 606), the visualization module 904 may first align the operator blocks that are in a same state with relation to the other block (e.g., second and third operator blocks both receive input from the first operator block or the second and third operator blocks both output to the first operator block), and then may position the different state block so that the midpoint of the edge of the different state block facing the same state blocks is aligned with a midpoint of one of the different states blocks or is aligned with a midpoint between the adjacent vertices of the same state blocks. As another non-exhaustive example, in some embodiments, when there is one block outputting to four blocks, for example, the operators may be placed in the layout using a proximity algorithm.

Next, in S318, the visualization module 904 determines how far apart the first operator block 602 is from the adjacent second operator block 604. In one or more embodiments, the visualization module 904 may determine the distance based on the number of elements already present on the canvas. As a non-exhaustive example, when there are only two operator blocks on the canvas, a rule 906 may indicate that the distance between the first operator block and the second operator block is calculated and tuned according to the number of operators in the canvas with which users can achieve consistency, whereas when there are four operator blocks on the canvas, the distance between each pair of adjacent blocks is dynamically adjusted to suit the operator readability. Other suitable rules may be used. It is also noted that as the dataflow model 404 may develop as more elements are added to (or removed from) the canvas, the visualization module 904 may, in one or more embodiments, dynamically change the distance between the blocks and the alignment of the elements with each incremental modification. It is also noted that the visualization module 904 may also use as an input the determined number of inputs and outputs for each operator block, as well as the number of operator blocks involved in the input/output, to determine the distance between adjacent operator blocks. As a non-exhaustive example, when a first operator block has two outputs, which are received as two inputs at the second operator block (or may be received as one input at the second operator block and one input at a third operator block), the first and second operator blocks may be closer together than when a first operator block has four outputs, which may be received as input at any of a second, third and fourth operator block.

After the distance between the blocks is determined, the connector 408 is selected in S320. The connector 408 indicates how data is flowing between the operator blocks 406. The connector 408 may indicate the direction of the data flow via arrows or any other suitable indicator. In one or more embodiments, the connector 408 may be user-selected or selected by the visualization module 904. Each connector 408 includes a first endpoint 410 and a second endpoint 412. The first endpoint 410 is coupled to one operator block and the second endpoint 412 is coupled to another operator block. The flow directional indicator (e.g., arrow) 411 may be placed at one of the endpoints, or at another position along the length of the connector. In S322, the length and orientation of a given connector 408 is determined based on the distance between the two operator blocks the connector is coupled to. The orientation of the connector may be a horizontal line, a vertical line, a diagonal line, a kinked line or any other suitable orientation.

In S324, the selected connector 408 is positioned on the canvas 402 to connect the two operator blocks 406. In one or more embodiments, the first endpoint 410 is coupled to the first operator block at a midpoint 430 of the first edge 422 of the first operator block and the second endpoint 412 is coupled to the second operator block at a midpoint 432 of the first edge of the second operator block 424. The first edge of the first operator block 422 and the first edge of the second operator block 424 face each other and are adjacent to each other.

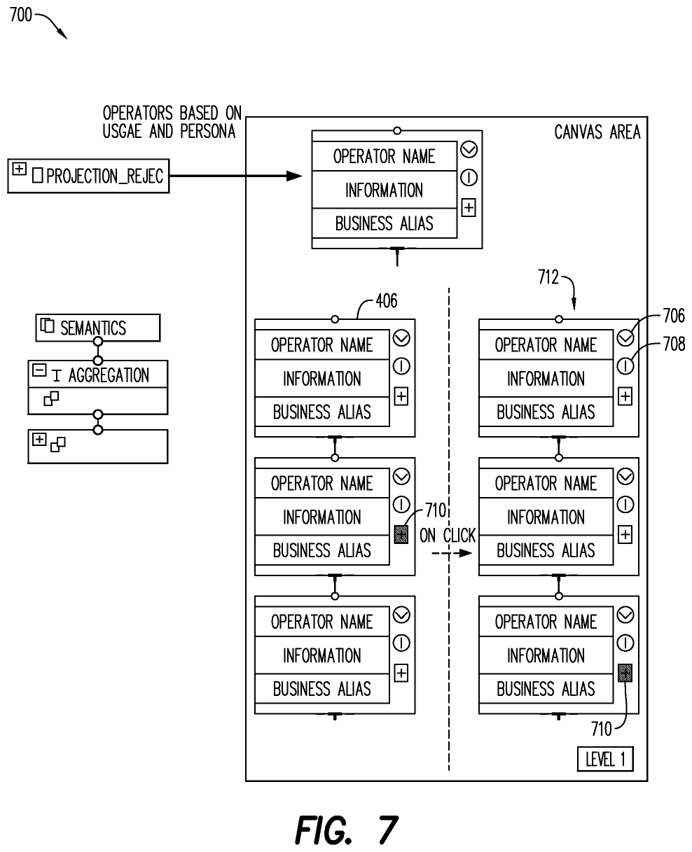

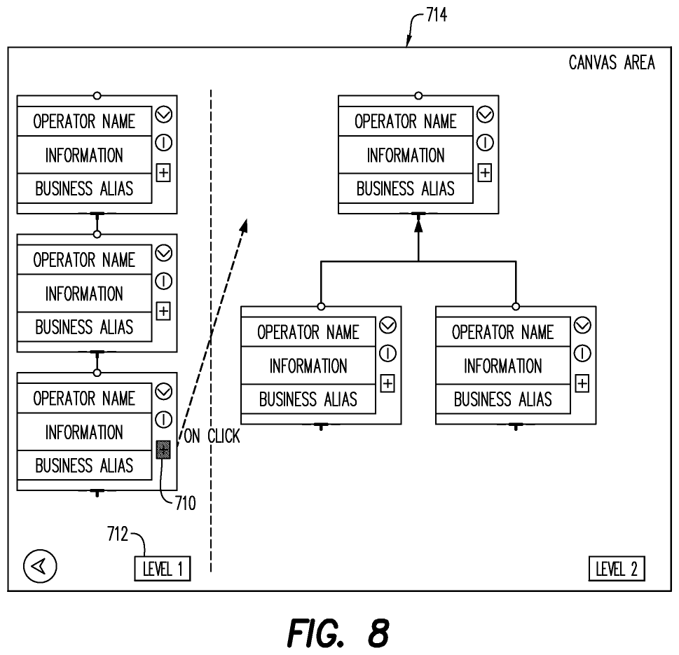

Turning to FIG. 7, a block diagram 700 of an executed data flow model 704 is provided. This data flow model 704 may have been created and then stored via process 200, described above. While the executed data flow model 704 shown herein has a single input and a single output, this is a non-exhaustive example and other numbers of inputs/outputs may be used. Each operator block 406 is overlaid using the information and annotations supplied by the database source 920 for that operator block that was pulled in to the dataflow model when the operator was moved onto the canvas 402 during dataflow model generation. In one or more embodiments, each operator block 406 may include a status indicator 706, an information indicator 708, and an expand control 710. The status indicator 706 may be rendered based on the state of the data flow. As a non-exhaustive example, the status indicator 706 may indicate one of: the data has successfully flowed through this operator block, the data has failed to flow through this operator block, and the data is currently flowing through this operator block. The status indicator 706 may reflect the status via color (e.g., green for success, red for failure, yellow for in progress), words, or any other suitable indicator. In one or more embodiments, the information indicator 708 may provide a detailed level of usage of the operator with recommendations for succeeding suitable operator placement. In one or more embodiments, the expand control 710 may be selected to present the levels of hierarchy present in a particular operator block. As used herein, “levels of hierarchy” may refer to the levels of operations depicted by operators for a particular business operation. For example, selection of the shaded expand control 710 in FIG. 7, results in the display of a first level of hierarchy 712. Then, selection of the shaded expanded control in the first level hierarchy in FIG. 7 and reproduced in FIG. 8, results in the display of a second level of hierarchy 714 in FIG. 8.

In one or more embodiments, the status indicator 706 may be used to debug the data flow model during execution thereof. For example, in the case of an error when the completed dataflow is executed, the user may be able to review the dataflow model 704 and easily discern from the status indicator 706 which operator block failed, which in turn may be the cause of the error. In one or more embodiments, the data store 920 may store a history of the execution of the dataflow model, including indications of failure as per the status indicator. A user, or other system, may analyze the history of dataflow model execution and its evolution, which may provide a tracing (a mechanism to debug through operators at runtime) to indicate an operator block may have an issue or a database source for the operator block may have an issue. In one or more embodiments, the dataflow model 404/704 may include data trace markers, which may denote the source for each dataflow. The source of any operator in a data flow may either be a table in database or database operation like aggregation, while annotations may intelligently present the information to the users. The data flow markers may include neural network mimic—this means that neural network models for the workflows may be designed and incorporated within the markers' information which would then create a simulation where the decisions of a set of operator behavior in a workflow is mimicked. One or more embodiments may include short label training for labeling the operator block with data flow marker details which may be a primary requirement for the recommendation and simulations to work and as such, a training set may be built for making recommendations closer to real scenarios.

FIG. 9 is a block diagram of system architecture 900 according to some embodiments. Embodiments are not limited to architecture 900 or to a three-tier database architecture.

Architecture 900 includes a dataflow application 902, a visualization module 904, a rules datastore 908, storing one or more rules 906, a database 920, a database management system (DBMS) 930, an application server 940, application(s) 945, and clients 950. Applications 904/945 may comprise server-side executable program code (e.g., compiled code, scripts, etc.) executing within application server 940 to receive queries from clients 950 and provide results to clients 950 based on data of database 920. A client 950 may access the dataflow application 902/visualization module 904 executing within application server 940, to generate the user interfaces 400, 600, 700 and 800 to create, execute and analyze a dataflow.

Application server 940 provides any suitable interfaces through which the clients 950 may communicate with the visualization module 904 or applications 902/945 executing on application server 940. For example, application server 940 may include a Hyper Text Transfer Protocol (HTTP) interface supporting a transient request/response protocol over Transmission Control Protocol/Internet Protocol (TCP/IP), a Web Socket interface supporting non-transient full-duplex communications which implement the Web Socket protocol over a single TCP/IP connection, and/or an Open Data Protocol (OData) interface.

One or more applications 902/945 executing on server 940 may communicate with DBMS 930 using database management interfaces such as, but not limited to, Open Database Connectivity (ODBC) and Java Database Connectivity (JDBC) interfaces. These types of applications 902/945 may use Structured Query Language (SQL) to manage and query data stored in database 920.

DBMS 930 serves requests to retrieve and/or modify data of database 920, and also performs administrative and management functions. Such functions may include snapshot and backup management, indexing, optimization, garbage collection, and/or any other database functions that are or become known. DBMS 930 may also provide application logic, such as database procedures and/or calculations, according to some embodiments. This application logic may comprise scripts, functional libraries and/or compiled program code.

Application server 940 may be separated from, or closely integrated with, DBMS 930. A closely integrated application server 940 may enable execution of server applications 902/945 completely on the database platform, without the need for an additional application server. For example, according to some embodiments, application server 940 provides a comprehensive set of embedded services which provide end-to-end support for Web-based applications. The services may include a lightweight web server, configurable support for OData, server-side JavaScript execution and access to SQL and SQLScript.

Application server 940 may provide application services (e.g., via functional libraries) which applications 902/945 may use to manage and query the data of database 920. The application services can be used to expose the database data model, with its tables, hierarchies, views and database procedures, to clients. In addition to exposing the data model, application server 940 may host system services such as a search service.

Database 920 may store data used by at least one of: applications 902/945 and the visualization module 904. For example, database 920 may store the dataflow modules 404.

Database 920 may comprise any query-responsive data source or sources that are or become known, including but not limited to a structured-query language (SQL) relational database management system. Database 920 may comprise a relational database, a multi-dimensional database, an eXtendable Markup Language (XML) document, or any other data storage system storing structured and/or unstructured data. The data of database 920 may be distributed among several relational databases, dimensional databases, and/or other data sources. Embodiments are not limited to any number or types of data sources.

In some embodiments, the data of database 920 may comprise one or more of conventional tabular data, row-based data, column-based data, and object-based data. Moreover, the data may be indexed and/or selectively replicated in an index to allow fast searching and retrieval thereof. Database 920 may support multi-tenancy to separately support multiple unrelated clients by providing multiple logical database systems which are programmatically isolated from one another.

Database 920 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Client 950 may comprise one or more individuals or devices executing program code of a software application for presenting and/or generating user interfaces to allow interaction with application server 940. Presentation of a user interface as described herein may comprise any degree or type of rendering, depending on the type of user interface code generated by application server 940.

For example, a client 950 may execute a Web Browser to request and receive a Web page (e.g., in HTML format) from a website application 902/945 of application server 940 to provide the unified UI 800 via HTTP, HTTPS, and/or Web Socket, and may render and present the Web page according to known protocols. The client 950 may also or alternatively present user interfaces by executing a standalone executable file (e.g., an .exe file) or code (e.g., a JAVA applet) within a virtual machine.

FIG. 10 is a block diagram of apparatus 1000 according to some embodiments. Apparatus 1000 may comprise a general- or special-purpose computing apparatus and may execute program code to perform any of the functions described herein. Apparatus 1000 may comprise an implementation of one or more elements of system 900. Apparatus 1000 may include other unshown elements according to some embodiments.

Apparatus 1000 includes visualization processor 1010 operatively coupled to communication device 1020, data storage device 1030, one or more input devices 1040, one or more output devices 1050 and memory 1060. Communication device 1020 may facilitate communication with external devices, such as application server 940. Input device(s) 1040 may comprise, for example, a keyboard, a keypad, a mouse or other pointing device, a microphone, knob or a switch, an infra-red (IR) port, a docking station, and/or a touch screen. Input device(s) 1040 may be used, for example, to manipulate graphical user interfaces and to input information into apparatus 1000. Output device(s) 1050 may comprise, for example, a display (e.g., a display screen) a speaker, and/or a printer.

Data storage device/memory 1030 may comprise any device, including combinations of magnetic storage devices (e.g., magnetic tape, hard disk drives and flash memory), optical storage devices, Read Only Memory (ROM) devices, Random Access Memory (RAM) etc.

The storage device 1030 stores a program 1012 and/or visualization platform logic 1014 for controlling the processor 1010. The processor 1010 performs instructions of the programs 1012, 1014, and thereby operates in accordance with any of the embodiments described herein, including but not limited to process 200/300.

The programs 1012, 1014 may be stored in a compressed, uncompiled and/or encrypted format. The programs 1012, 1014 may furthermore include other program elements, such as an operating system, a database management system, and/or device drivers used by the processor 1010 to interface with peripheral devices.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 900 may include a processor to execute program code such that the computing device operates as described herein.

All systems and processes discussed herein may be embodied in program code stored on one or more computer-readable non-transitory media. Such non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A computer-implemented method comprising:
receiving, at a user interface, a plurality of operator blocks and at least one connector for connecting the operator blocks to generate a dataflow model, wherein each connector includes a first endpoint and a second endpoint;
receiving an annotation file for each operator, wherein the annotation file is received when the operator is received at the user interface;
receiving at the user interface a positioning of each connector to connect two operator blocks; and
generating a layout of the dataflow model on the user interface based on one or more semantic rules and one or more geometric rules.

2. The computer-implemented method of claim 1, wherein the one or more semantic rules and one or more geometric rules further comprise:
determining an amount of inputs for each operator block;
determining an amount of outputs for each operator block; and
determining a distance between the first endpoint and the second endpoint for each connector.

3. The computer-implemented method of claim 2, wherein generating the layout of the dataflow model further comprises:
dynamically aligning a midpoint of a first operator block with a midpoint of a second operator block; and
dynamically positioning the first endpoint of the connector at an output of the first aligned operator block and the second endpoint of the connector at an input of the second aligned operator block.

4. The computer-implemented method of claim 3, wherein the alignment is one of horizontal and vertical.

5. The computer-implemented method of claim 3,
wherein the first endpoint is positioned on a side of the aligned first operator block facing the aligned second operator block at a midpoint of the side of the aligned first operator block facing the aligned second operator block, when the first operator block has one output, and
wherein the second endpoint is positioned on a side of the aligned second operator block facing the aligned first operator block at a midpoint of the side of the aligned second operator block facing the aligned first operator block, when the second operator block has one input.

6. The computer-implemented method of claim 1 further comprising,
receiving a first operator block having a first output and a second output, wherein the first output is received at a second operator block and the second output is received at a third operator block;
dynamically aligning a midpoint of the first operator block with a midpoint of the second operator, wherein the first operator block is adjacent to the second operator block;
dynamically aligning a midpoint of the third operator block with a midpoint of the second operator block, wherein a first side of the third operator block faces a side of the second operator block and a second side of the third operator block faces a side of the first operator block, and the first side of the third operator block is different from the second side of the third operator block;
receiving a first connector to connect the first operator block to the second operator block;
receiving a second connector to connect the first operator block to the third operator block;
positioning a first endpoint of the first connector on a side of the aligned first operator block facing the aligned second operator block at a midpoint of the side of the aligned first operator block facing the aligned second operator block;
positioning a second endpoint of the first connector on a side of the aligned second operator block facing the aligned first operator block at a midpoint of the side of the aligned second operator block facing the aligned first operator block;
positioning a first endpoint of the second connector at a midpoint of the first connector; and
positioning a second endpoint of the second connector at a midpoint of the third operator block on a side facing the first operator block.

7. The method of claim 1, wherein the second connector includes a right angle.

8. The method of claim 1, further comprising:
segmenting the dataflow model by determining an underlying JSON code segment for each operator block; and
determining a semantic alignment for each determined underlying JSON code segment.

9. A system comprising:
a display;
a visualization module;
a memory storing processor-executable steps: and
a visualization processor operative with the visualization module to execute the processor-executable process steps to cause the system to:
receive, at a user interface, a plurality of operator blocks and at least one connector for connecting the operator blocks to generate a dataflow model, wherein each connector includes a first endpoint and a second endpoint;
receive an annotation file for each operator, wherein the annotation file is received when the operator is received at the user interface;
receive at the user interface a positioning of each connector to connect two operator blocks; and.
generate a layout of the dataflow model on the user interface based on one or more semantic rules and one or more geometric rules.

10. The system of claim 9, wherein the one or more semantic rules and one or more geometric rules further comprise processor-executable process steps to cause the system to:
determine an amount of inputs for each operator block;
determine an amount of outputs for each operator block; and
determine a distance between the first endpoint and the second endpoint for each connector.

11. The system of claim 10, wherein generating the layout of the dataflow model further comprises processor-executable process steps to cause the system to:
dynamically align a midpoint of a first operator block with a midpoint of a second operator block; and
dynamically position the first endpoint of the connector at an output of the first aligned operator block and the second endpoint of the connector at an input of the second aligned operator block.

12. The system of claim 11, wherein the alignment is one of horizontal and vertical.

13. The system of claim 11,
wherein the first endpoint is positioned on a side of the aligned first operator block facing the aligned second operator block at a midpoint of the side of the aligned first operator block facing the aligned second operator block, when the first operator block has one output, and
wherein the second endpoint is positioned on a side of the aligned second operator block facing the aligned first operator block at a midpoint of the side of the aligned second operator block facing the aligned first operator block, when the second operator block has one input.

14. The system of claim 9 further comprising processor-executable process steps to cause the system to:
receive a first operator block having a first output and a second output, wherein the first output is received at a second operator block and the second output is received at a third operator block;
dynamically align a midpoint of the first operator block with a midpoint of the second operator, wherein the first operator block is adjacent to the second operator block;
dynamically align a midpoint of the third operator block with a midpoint of the second operator block, wherein a first side of the third operator block faces a side of the second operator block and a second side of the third operator block faces a side of the first operator block, and the first side of the third operator block is different from the second side of the third operator block;
receive a first connector to connect the first operator block to the second operator block;
receive a second connector to connect the first operator block to the third operator block;
position a first endpoint of the first connector on a side of the aligned first operator block facing the aligned second operator block at a midpoint of the side of the aligned first operator block facing the aligned second operator block;
position a second endpoint of the first connector on a side of the aligned second operator block facing the aligned first operator block at a midpoint of the side of the aligned second operator block facing the aligned first operator block;
position a first endpoint of the second connector at a midpoint of the first connector; and
position a second endpoint of the second connector at a midpoint of the third operator block on a side facing the first operator block.

15. The system of claim 9, further comprising:
segmenting the dataflow model by determining an underlying JSON code segment for each operator block; and
determining a semantic alignment for each determined underlying JSON code segment.

16. A non-transitory computer-readable medium storing program code, the program code executable by a computer system to cause the computer system to:
receive, at a user interface, a plurality of operator blocks and at least one connector for connecting the operator blocks to generate a dataflow model, wherein each connector includes a first endpoint and a second endpoint;
receive an annotation file for each operator, wherein the annotation file is received when the operator is received at the user interface;
receive at the user interface a positioning of each connector to connect two operator blocks
determine an amount of inputs for each operator block;
determine an amount of outputs for each operator block;
determine a distance between the first endpoint and the second endpoint for each connector; and.
generate a layout of the dataflow model on the user interface based on the determined amount of inputs, determined amount of outputs, distance between the first endpoint and the second endpoint for each connector.

17. The medium of claim 16, wherein generating the layout of the dataflow model further comprises program code to cause the computer system to:
dynamically align a midpoint of a first operator block with a midpoint of a second operator block; and
dynamically position the first endpoint of the connector at an output of the first aligned operator block and the second endpoint of the connector at an input of the second aligned operator block.

18. The medium of claim 16, wherein the alignment is one of horizontal and vertical.

19. The medium of claim 18,
wherein the first endpoint is positioned on a side of the aligned first operator block facing the aligned second operator block at a midpoint of the side of the aligned first operator block facing the aligned second operator block, when the first operator block has one output, and
wherein the second endpoint is positioned on a side of the aligned second operator block facing the aligned first operator block at a midpoint of the side of the aligned second operator block facing the aligned first operator block, when the second operator block has one input.

20. The medium of claim 16 further comprising program code to cause the computer system to:
receive a first operator block having a first output and a second output, wherein the first output is received at a second operator block and the second output is received at a third operator block;
dynamically align a midpoint of the first operator block with a midpoint of the second operator, wherein the first operator block is adjacent to the second operator block;
dynamically align a midpoint of the third operator block with a midpoint of the second operator block, wherein a first side of the third operator block faces a side of the second operator block and a second side of the third operator block faces a side of the first operator block, and the first side of the third operator block is different from the second side of the third operator block;
receive a first connector to connect the first operator block to the second operator block;
receive a second connector to connect the first operator block to the third operator block;
position a first endpoint of the first connector on a side of the aligned first operator block facing the aligned second operator block at a midpoint of the side of the aligned first operator block facing the aligned second operator block;
position a second endpoint of the first connector on a side of the aligned second operator block facing the aligned first operator block at a midpoint of the side of the aligned second operator block facing the aligned first operator block;
position a first endpoint of the second connector at a midpoint of the first connector; and
position a second endpoint of the second connector at a midpoint of the third operator block on a side facing the first operator block.
